(19) United States
(12) Patent Application Publication
(10) Pub. No.: US 2018/0153347 A1
(43) Pub. Date: Jun. 7, 2018

(54) SIDE-SURFACE DIRECT-FLAME ROASTING DEVICE

(71) Applicant: Jaebeom PARK, Jeonju-si (KR)

(72) Inventor: Jaebeom PARK, Jeonju-si (KR)

(21) Appl. No.: 15/565,158

(22) PCT Filed: Apr. 6, 2016
(86) PCT No.: PCT/KR2016/003572

§ 371 Date: Jan. 18, 2018

(30) Foreign Application Priority Data
Apr. 7, 2015 (KR) 10-2015-0049024

(51) Int. Cl. A47J 37/07

(52) U.S. Cl. CPC A47J 37/0718; A47J 37/0781; A47J 37/0731

(57) ABSTRACT

The present invention relates to a side-surface direct-flame roasting device, and more specifically relates to a side-surface direct-flame roasting device wherein a grill for roasting meat is vertically disposed and heating units, which respectively contain heat sources, are disposed on both sides of the grill such that the taste of the meat and convenience for the user can be improved as the roasting time is reduced since both sides of the meat are simultaneously uniformly roasted, and the fat produced from the meat does not splash the user but rather collects and is removed at the bottom due to the vertically positioned grill.

### TECHNICAL FIELD

The present invention relates to a vertical grilling apparatus, and more particularly, to a vertical grilling apparatus in which a gridiron for fixing meat is provided vertically and heaters each containing a heat source are provided at two sides of the gridiron and by which both sides of the meat may be simultaneously and uniformly roasted to reduce a roasting time, and fat melted from the meat may flow downward along the vertically provided gridiron due to gravity without dripping directly on the heat source, e.g., charcoal, to prevent harmful substances, e.g., dioxins, produced by the burnt fat and to prevent smoke, soot, burning of the meat, etc., and may be easily collected and discharged without being spattered on a user, thereby enhancing taste of the meat, increasing convenience in use, and achieving only the advantages of grilling.

### BACKGROUND ART

Currently, as many people live in comfortable circumstances and eat less vegetables, intake of fish and various types of meat, e.g., beef, pork, chicken, and duck, is greatly increased and traditional meat cooking methods, e.g., boiling and steaming, are diversified to roasting, grilling, etc.

Various methods of grilling beef, pork, chicken, etc. are known. Nowadays, a grilling method using charcoal or firewood is popularized, and a grilling method using gas as a fuel and a barbecue grilling method for cooking skewered meat are still used.

An apparatus for grilling meat is divided into an electric grilling apparatus, a gas grilling apparatus, and a charcoal grilling apparatus.

The gas grilling apparatus may not be easily used because control of gas flames is not easy and taste of meat varies depending on the shape of the flames and a heating method. Furthermore, taste of meat roasted using the charcoal grilling apparatus is superior to that of meat roasted using the electric grilling apparatus or the gas grilling apparatus. As such, customers prefer the charcoal grilling apparatus.

In addition, the charcoal grilling apparatus or the barbecue grilling method roasts meat using flames generated when charcoal or firewood burns, and heat of the flames, and may enhance texture and taste of the meat due to far-infrared radiation caused when the charcoal or firewood burns.

Therefore, charcoal is generally and commonly used to roast meat such as beef, pork, and duck in restaurants and homes in order to remove bad smell of the meat and to enhance taste thereof.

As a general method of grilling various types of meat on fire, Korean Patent Registration No. 10-0938638 discloses a method of putting a gridiron plate on a fire pot containing a heat source such as charcoal, and putting meat on the gridiron plate to roast the meat using heating power of the heat source.

However, using the above-described general grilling method, if heating power is excessively high or the gridiron plate is excessively heated, in many cases, the outside of the meat is excessively burnt while the inside of the meat is undercooked. Therefore, heating power should be frequently controlled or the gridiron plate should be frequently changed while the meat is being roasted, thereby causing inconvenience.

In particular, when the meat is roasted and cooked in an outdoor environment, heating power of the heat source contained in the fire pot may not be easily controlled and thus the meat may not be roasted to an optimal state.

Furthermore, using conventional grilling apparatuses, since fat melted from the roasted meat drips directly on the heat source such as charcoal, various harmful substances and smoke may be produced and thus the cooked meat may be covered with soot or may be burnt, thereby deteriorating taste of the meat and damaging health.

### DISCLOSURE

### Technical Problem

Therefore, the present invention has been made in view of the above problems, and it is one object of the present invention to provide a vertical grilling apparatus in which a gridiron for fixing meat is vertically inserted into a body of the vertical grilling apparatus and heaters each containing a heat source are provided at two sides of the gridiron and by which both sides of the meat may be simultaneously and uniformly roasted.

It is another object of the present invention to provide a vertical grilling apparatus by which both sides of meat may be simultaneously roasted, the meat may not be turned over, and a roasting time may be reduced.

It is another object of the present invention to provide a vertical grilling apparatus in which the distance between a gridiron for fixing meat and heaters is adjustable and by which the distance may be adjusted depending on heating power of a heat source not to burn the meat and to roast the meat to an optimal state, thereby enhancing taste and texture of the meat.

It is yet another object of the present invention to provide a vertical grilling apparatus by which fat melted from meat may flow downward and then may be collected and discharged without being spattered on a user to prevent burns, and the fat may not drip directly on a heat source to prevent harmful substances, e.g., dioxins, produced by the burnt fat and to prevent smoke, soot, burning of the meat, etc., thereby enhancing taste of the meat and increasing convenience in use.

### Technical Solution

In accordance with one aspect of the present invention, provided is a vertical grilling apparatus including a body 100 including a plurality of vertical frames 110 used as support poles, and a plurality of horizontal frames 120 connected to upper and lower parts of the vertical frames 110 perpendicularly to the vertical frames 110, a wall structure 200 provided on a top surface of the body 100 and made of a material capable of reflecting heat, heaters 300 each provided in a box shape having a top opening to contain a heat source, and including a perforated plate 311 or 321 foldably coupled to the top opening, a plurality of air holes 312 or 322 provided in a bottom surface of the heater 300, a handle 313 or 323 protruding from a side surface of the heater 300, and a first heating means 310 or a second heating means 320 inserted into the body 100 in such a manner that the bottom surface is perpendicular to the horizontal frames 120, and a gridiron 400 including two hinge-coupled rectangular gridiron plates 410 and inserted into the body 100 between the first and second heating means 310 and 320 to be spaced apart from the first and second heating means 310 and 320 by a certain distance and to be perpendicular to the horizontal frames 120, wherein the first and second heating means 310 and 320 are inserted into the body 100 in such a manner that the perforated plates 311 and 321 face each other,

A gridiron fixer 121 for fixing the gridiron 400 and a heater fixer 122 for fixing the heaters 300 may be provided on the horizontal frames 120.

A spacer means 330 for providing a space between the bottom surface of the heater 300 and the heat source, and a position fixing means 340 provided on the spacer means 330 to fix a position of the heat source may be provided in the heater 300.

A fixing means 350 for preventing the perforated plate 311 or 321 from being unfolded may be further provided on the heater 300.

### Advantageous Effects

As described above, according to the present invention, a vertical grilling apparatus in which a gridiron for fixing meat is vertically inserted into a body of the vertical grilling apparatus and heaters each containing a heat source are provided at two sides of the gridiron and by which both sides of the meat may be simultaneously and uniformly roasted may be provided.

Furthermore, both sides of the meat may be simultaneously roasted, the meat may not be turned over, and a roasting time may be reduced.

In addition, since the distance between the gridiron for fixing the meat and the heaters is adjustable, the distance may be adjusted depending on heating power of the heat source not to burn the meat and to roast the meat to an optimal state, thereby enhancing taste and texture of the meat.

Besides, fat melted from the meat may flow downward and then may be collected and discharged without being spattered on a user to prevent burns, and the fat may not drip directly on the heat source to prevent harmful substances, e.g., dioxins, produced by the burnt fat and to prevent smoke, soot, burning of the meat, etc., thereby enhancing taste of the meat and increasing convenience in use.

### DESCRIPTION OF DRAWINGS

FIG. 1 is a perspective view of a vertical grilling apparatus according to the present invention.

FIG. 2 is an exploded perspective view of a heater of the vertical grilling apparatus according to the present invention.

FIG. 3 is a front view of a body and a wall structure of the vertical grilling apparatus according to the present invention.

FIG. 4 is a front view of the vertical grilling apparatus according to the present invention.

FIG. 5 is a side view of the heater of the vertical grilling apparatus according to the present invention.

### BEST MODE

Advantages and features of one or more embodiments of the present disclosure and methods of accomplishing the same may be understood more readily by reference to the following detailed description of the embodiments and the accompanying drawings. In this regard, the present embodiments may have different forms and should not be construed as being limited to the descriptions set forth herein. Rather, these embodiments are provided so that this disclosure will be thorough and complete and will fully convey the concept of the present embodiments to one of ordinary skill in the art, and the present disclosure will only be defined by the appended claims. In the drawings, like reference numerals denote like elements.

In the following description of the present invention, a detailed description of known functions and configurations incorporated herein will be omitted when it may make the subject matter of the present invention unclear. The terms used in the specification are defined in consideration of functions used in the present invention, and can be changed according to the intent or conventionally used methods of clients, operators, and users. Accordingly, definitions of the terms should be understood on the basis of the entire description of the present specification.

Hereinafter, the present invention will be described in detail by explaining embodiments of the invention with reference to the attached drawings.

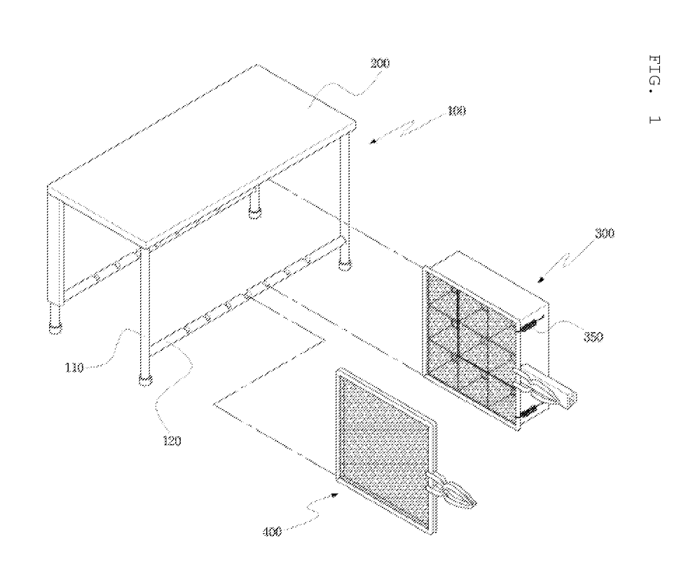

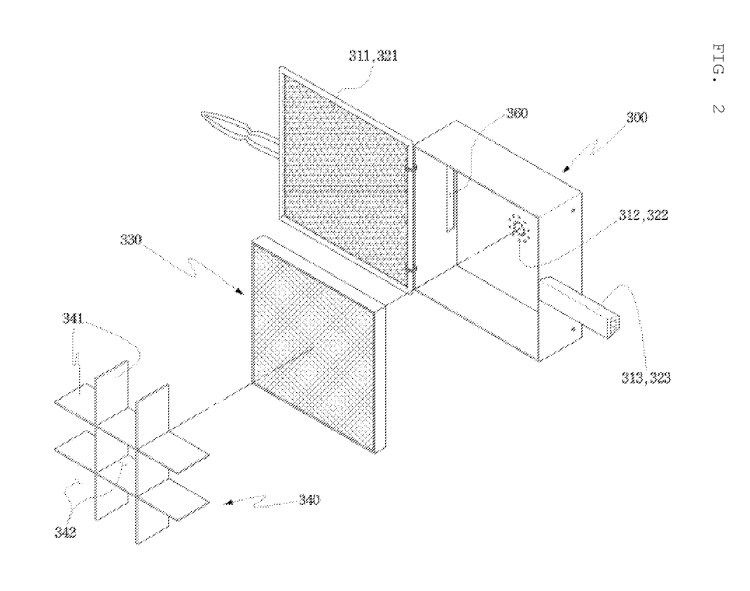

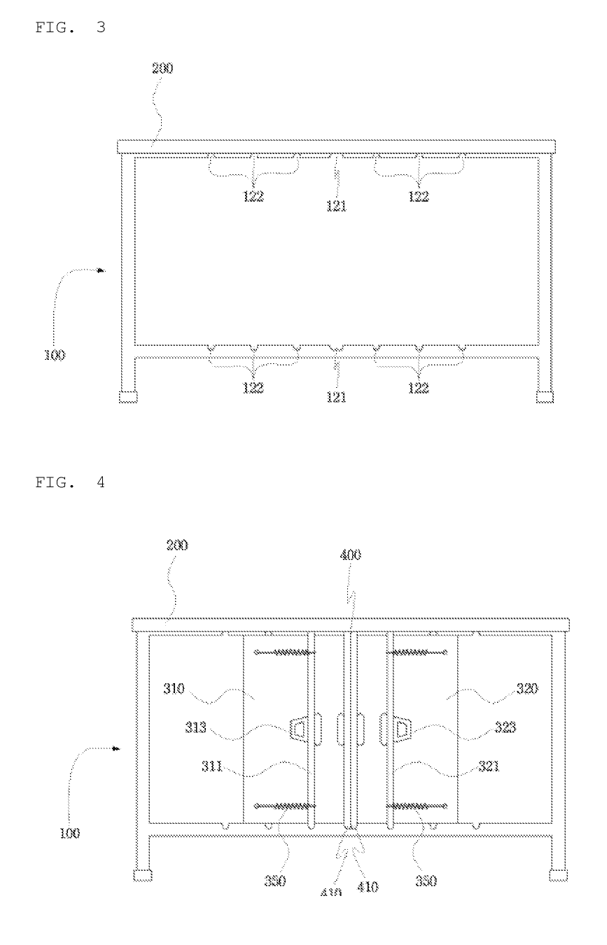

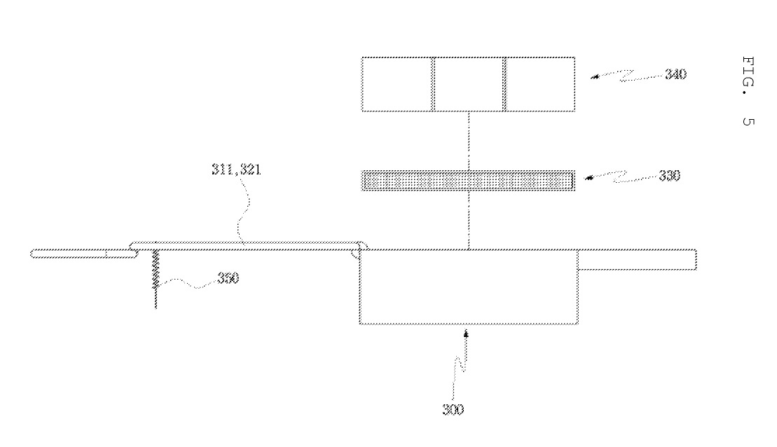

FIG. 1 is a perspective view of a vertical grilling apparatus according to the present invention, FIG. 2 is an exploded perspective view of a heater of the vertical grilling apparatus according to the present invention, FIG. 3 is a front view of a body and a wall structure of the vertical grilling apparatus according to the present invention, FIG. 4 is a front view of the vertical grilling apparatus according to the present invention, and FIG. 5 is a side view of the heater of the vertical grilling apparatus according to the present invention. Only a second heating means is illustrated and a first heating means is omitted in FIG. 1.

The vertical grilling apparatus according to the present invention may include a body 100, a wall structure 200, heaters 300, and a gridiron 400. The vertical grilling apparatus of the present invention may be used to roast foods such as meat and various vegetables.

Initially, the body 100 may include a plurality of vertical frames 110 used as support poles, and a plurality of horizontal frames 120 connected to upper and lower parts of the vertical frames 110 perpendicularly to the vertical frames 110.

The above-described body 100 may be produced using a nonferrous metal which is resistant to corrosion, a synthetic resin, an engineering plastic which is a high-strength synthetic resin, or stainless steel which has high strength and is resistant to corrosion.

A gridiron fixer 121 for fixing the gridiron 400 and a heater fixer 122 for fixing the heaters 300 may be symmetrically provided on the horizontal frames 120. The gridiron fixer 121 may be provided at the center of the horizontal frames 120, and the heater fixer 122 may be symmetrically provided in a plural number at two sides of the gridiron fixer 121 at equal intervals.

Since the heater fixer 122 is provided in a plural number, a position into which the heaters 300 are inserted may be selectively controlled depending on heating power and the distance between a heat source and meat to be roasted may be simply adjusted to prevent the meat from being burnt or undercooked.

In this case, the gridiron fixer 121 and the heater fixer 122 may be provided as recesses or guide rails capable of mounting the gridiron 400 and the heaters 300 therein.

The wall structure 200 may be provided on a top surface of the body 100, and may be made of a material capable of reflecting heat.

The wall structure 200 may prevent emission of heat upward from the body 100 so as not to transfer the heat to people adjacent to the vertical grilling apparatus, or may serve as a table for roasted meat, raw meat to be roasted, dishware, or the like.

The wall structure 200 provided on the body 100 may further include an auxiliary heater (not shown), and meat roasted by the heaters 300 to be described below may not be cooled but maintained at a user-desired temperature by the auxiliary heater. In this case, the auxiliary heater may be height-adjustable.

In addition, the auxiliary heater may be inclined to easily discharge fat melted from the meat put on the auxiliary heater. In this case, a discharge hole may be further provided in the wall structure 200 and the auxiliary heater may be connected to the discharge hole using a connector to guide the fat to the drip pan to be described below.

The auxiliary heater may be a heating means such as a gas burner.

A hole (not shown) may be further provided in a selected space of the wall structure 200 and meat to be roasted may be inserted through the hole. In this case, the meat may be inserted and fixed by an additional device for inserting and fixing the meat. A removable lid may be provided on the hole. As such, the meat to be roasted may be inserted from above the vertical grilling apparatus to increase utilization of the vertical grilling apparatus, and the additional device for inserting the meat may be provided to prevent accidents, e.g., injury of a user by fire.

The wall structure 200 may be further provided on rear and side surfaces of the body 100 to prevent emission of heat to an ambient environment of the vertical grilling apparatus.

The wall structure 200 may be produced using heat-resistant tempered glass such that internal heat may not be transferred to the outside and the user may view the inside.

The wall structure 200 may be configured as a fire pot surrounding the body 100 and, in this case, the wall structure 200 may be made of clay.

Each heater 300 is provided in a box shape having a top opening to contain a heat source, and includes a perforated plate 311 or 321 foldably coupled to the top opening, a plurality of air holes 312 or 322 provided in a bottom surface of the heater 300, a handle 313 or 323 protruding from a side surface of the heater 300, and a first heating means 310 or a second heating means 320 inserted into the body 100 in such a manner that the bottom surface is perpendicular to the horizontal frames 120.

In this case, the first and second heating means 310 and 320 are inserted into the body 100 in such a manner that the perforated plates 311 and 321 face each other. Accordingly, both surfaces of the meat may be simultaneously roasted by supplying heat from two sides of the gridiron 400 and thus a time taken to roast the meat may be reduced.

The heat source may include firewood, charcoal, or the like.

The perforated plate 311 or 321 may be longer than the width of the heater 300. As shown in the drawings, parts of the perforated plate 311 or 321 may be mounted in the heater fixer 122 configured as recesses and thus the heater 300 may be inserted into and fixed to the body 100.

A fixing means 350 may be further provided at a side of the heater 300 to prevent the perforated plate 311 or 321 from being unfolded. As shown in the drawings, the fixing means 350 may be a device using tensile force of springs. However, the fixing means 350 is not limited thereto and any device capable of maintaining a folded state of the perforated plate 311 or 321 is usable.

The air holes 312 or 322 are provided in the bottom surface of the heater 300. The air holes 312 or 322 may supply external fresh air to the heat source in the heater 300, thereby increasing heating power of the heater 300 and reducing the amount of ash.

A through-hole 360 may be further provided in a side surface of the heater 300 to increase the efficiency of circulating air to and from the outside.

Therefore, oxygen required to burn the heat source may be appropriately supplied into the heater 300 through the air holes 312 or 322 and the through-hole 360.

A briquette fixing frame (not shown) may be further provided on the bottom surface of the heater 300. Briquettes may be provided in the briquette fixing frame to facilitate ignition of the heat source and, if necessary, the heat source and the briquettes may be used together to increase heating power of the heater 300.

The heater 300 may be produced as a small camping pot or pan made of stainless steel, and thus may be used for camping.

The gridiron 400 includes two hinge-coupled rectangular gridiron plates 410 and is inserted into the body 100 between the first and second heating means 310 and 320 to be spaced apart from the first and second heating means 310 and 320 by a certain distance and to be perpendicular to the horizontal frames 120.

Since meat to be roasted is put between the two gridiron plates 410 and the gridiron 400 is inserted into the body 100, the meat may be roasted by the first and second heating means 310 and 320 positioned at two sides of the gridiron 400.

In this case, since the gridiron 400 is fixed by the gridiron fixer 121 provided on the horizontal frames 120, the two hinge-coupled gridiron plates 410 may not be unfolded but may be maintained in a folded state.

A gridiron fixing means (not shown) capable of preventing the two gridiron plates 410 from being unfolded may be further provided on the gridiron 400.

In addition, a handle capable of utilizing insertion or separation of the gridiron 400 into or from the body 100 may be further provided on the gridiron 400.

Since the gridiron 400 is inserted perpendicularly to the horizontal frames 120, when meat is roasted, fat melted from the meat flows along the gridiron 400 to a lower part of the vertical grilling apparatus. In this case, the body 100 may further include a drip pan (not shown) to collect the fat.

As described above, since the gridiron 400 is inserted perpendicularly to the horizontal frames 120 and the fat of the roasted meat flows downward, the fat may not be spattered on people adjacent to the vertical grilling apparatus. In addition, since the fat does not drip on the heat source, the heat source may not produce smoke and the meat may not be covered with soot, thereby enhancing the taste of the meat.

Alternatively, the gridiron 400 may include a rectangular gridiron plate and a diamond-shaped gridiron plate which are hinge-coupled to each other. Using the above-described gridiron 400, the fat of the meat flows downward along the edge of the diamond-shaped gridiron plate and thus may be guided to flow downward to a certain place. Accordingly, the fat of the meat may be easily collected or processed.

A spacer means 330 for providing a space between the bottom surface of the heater 300 and the heat source may be further provided in the heater 300.

The spacer means 330 is used to prevent direct contact between the heat source and the bottom surface of the heater 300, is provided in the same shape as the bottom surface, has a certain height in such a manner that the heat source is spaced apart from the bottom surface, and includes a plurality of holes.

Since the heat source is not in contact with the bottom surface due to the spacer means 330 having a plurality of holes, the efficiency of circulating air may be increased and thus the air may be sufficiently supplied to the heat source.

In addition, the spacer means 330 may limit a space for containing the heat source in the heater 300 and thus the user may use only a desired amount of the heat source.

For example, if a small amount of the heat source is placed in the heater 300 without using the spacer means 330 and the heater 300 is inserted into the body 100, since the heat source moves in the heater 300 toward the ground surface and is concentrated in a certain part, heat may not be uniformly transferred to the gridiron 400 and thus only a part of meat at a lower side of the gridiron 400 may be cooked or burnt while the other part of the meat at an upper side of the gridiron 400 may be undercooked. Accordingly, by providing the spacer means 330 to limit the size of the space where the heat source is placed, the heat source may be prevented from being concentrated in a certain part of the heater 300 and thus heat may be uniformly applied to the gridiron 400.

A position fixing means 340 for fixing a position of the heat source may be provided in the heater 300. The position fixing means 340 may prevent the heat source from moving toward the ground surface when the heater 300 is vertically inserted into the body 100, and may support the heat source to be uniformly dispersed in the heater 300, thereby uniformly applying heat to the gridiron 400 to roast meat. Therefore, since the meat is uniformly roasted, taste of the meat may be enhanced, a time taken to roast the meat may be reduced, and the meat may be prevented from being partially burnt.

The position fixing means 340 may include a plurality of plates 341 connected perpendicularly to each other, and spaces 342 may be defined by the plates 341. Preferably, the position fixing means 340 is provided in a ‘#’ shape as shown in the drawings, and the shape thereof is not limited thereto.

When the position fixing means 340 is provided in the heater 300, the heat source is positioned in the spaces 342 defined by the position fixing means 340. As such, even when the heater 300 is vertically inserted into the body 100, the heat source may be prevented from moving toward the ground surface and heat may be uniformly transferred to the gridiron 400, thereby uniformly cooking the meat.

Only one of the spacer means 330 and the position fixing means 340 may be provided in the heater 300, or both may be provided in the heater 300 together. When both are provided together, preferably, the position fixing means 340 is provided on the spacer means 330.

A thermometer for measuring internal temperature of the vertical grilling apparatus may be further provided in the vertical grilling apparatus.

In the above-described vertical grilling apparatus according to the present invention, since a gridiron 400 for fixing meat is vertically inserted into a body 100 and a heat source is provided at two sides of the meat, both sides of the meat may be simultaneously roasted to reduce a roasting time, and fat melted from the meat may flow downward not to be spattered on a user, and may not drip on the heat source to prevent smoke from the heat source and to prevent soot on the meat.

Furthermore, the distance between the meat and heaters may be adjusted. For example, when heating power is excessively high, the distance between the meat and heaters may be increased to prevent the meat from being burnt. When heating power is excessively low, the distance between the meat and heaters may be reduced to prevent the meat from being undercooked. As such, the meat may be roasted with appropriate amounts of moisture and juices not to burn the outside of the meat and thus taste of the meat may be enhanced.

In addition, since flames generated when the heat source burns are not in direct contact with the meat, transformation of the meat or hardening of the meat after a certain time may be prevented.

While the present invention has been particularly shown and described with reference to embodiments thereof, it will be understood by one of ordinary skill in the art that various changes in form and details may be made therein without departing from the spirit and scope of the present invention as defined by the following claims.
100 Body
110: Vertical frames
101 120: Horizontal frames
121: Gridiron fixer
122: Heater fixer
200: Wall structure
300: Heater
310: First heating means
320: Second heating means
311, 321: Perforated plate
312, 322: Air holes
313, 323: Handle
330: Spacer means
340: Position fixing means
350: Fixing means
360: Through-hole
400: Gridiron
410: Gridiron plates

1. A vertical grilling apparatus comprising:
a body 100 including a plurality of vertical frames 110 used as support poles, and a plurality of horizontal frames 120 connected to upper and lower parts of the vertical frames 110 perpendicularly to the vertical frames 110;
a wall structure 200 provided on a top surface of the body 100 and made of a material capable of reflecting heat;
heaters 300 each provided in a box shape having a top opening to contain a heat source, and comprising a perforated plate 311 or 321 foldably coupled to the top opening, a plurality of air holes 312 or 322 provided in a bottom surface of the heaters 300, a handle 313 or 323 protruding from a side surface of the heaters 300, and a first heating means 310 or a second heating means 320 inserted into the body 100 in such a manner that the bottom surface of the heaters 300 is perpendicular to the horizontal frames 120; and
a gridiron 400 comprising two hinge-coupled rectangular gridiron plates 410 and inserted into the body 100 between the first and second heating means 310 and 320 to be spaced apart from the first and second heating means 310 and 320 by a certain distance and to be perpendicular to the horizontal frames 120,
wherein the first and second heating means 310 and 320 are inserted into the body 100 in such a manner that the perforated plates 311 and 321 face each other,
wherein a spacer means 330 for providing a space between the bottom surface of the heater 300 and the heat source, and a position fixing means 340 provided on the spacer means 330 to fix a position of the heat source are provided in the heater 300.

2. The vertical grilling apparatus according to claim 1, wherein a gridiron fixer 121 for fixing the gridiron 400 and a heater fixer 122 for fixing the heaters 300 are provided on the horizontal frames 120.

3. The vertical grilling apparatus according to claim 1, wherein a fixing means 350 for preventing the perforated plate 311 or 321 from being unfolded is further provided on the heater 300.
